(19) United States
(12) Patent Application Publication
(10) Pub. No.: US 2015/0095614 A1
(43) Pub. Date: Apr. 2, 2015

(54) APPARATUS AND METHOD FOR EFFICIENT MIGRATION OF ARCHITECTURAL STATE BETWEEN PROCESSOR CORES

(71) Applicants: Bret L. Toll, Hillsboro, OR (US); Scott D. Hahn, Portland, OR (US); Jason W. Brandt, Austin, TX (US); Thomas F. Toll, Portland, OR (US)

(72) Inventors: Bret L. Toll, Hillsboro, OR (US); Scott D. Hahn, Portland, OR (US); Jason W. Brandt, Austin, TX (US); Thomas F. Toll, Portland, OR (US)

(21) Appl. No.: 14/040,230

(22) Filed: Sep. 27, 2013

(51) Int. Cl. G06F 9/38

(52) U.S. Cl. CPC G06F 9/3869; G06F 9/3885
USPC 712/42

(57) ABSTRACT

An apparatus and method are described for the efficient migration of architectural state between processor cores. For example, a processor according to one embodiment comprises: a first processing core having a first instruction execution pipeline including first register set for storing a first architectural state of a first thread being executed thereon; a second processing core having a second instruction execution pipeline including a second register set for storing a second architectural state of a second thread being executed thereon; and architectural state migration logic to perform a direct, simultaneous swap of the first architectural state from the first register set with the second architectural state from the second register set responsive to detecting that the execution of the first thread is to be migrated from the first core to the second core.

### BACKGROUND

1. Field of Invention

The field of invention pertains generally to computing systems, and, more specifically, to an apparatus and method for efficient migration of architectural state between processor cores.

2. Background

FIG. 1 shows the architecture of an exemplary multi-core processor 100. As observed in FIG. 1, the processor includes: 1) multiple processing cores 101_1 to 101_N; 2) an interconnection network 102; 3) a last level caching (LLC) system 103; 4) a memory controller 104 and an I/O hub 105. Each of the processing cores contain one or more instruction execution pipelines for executing program code instructions. The interconnect network 102 serves to interconnect each of the cores 101_1 to 101_N to each other as well as the other components 103, 104, 105. The last level caching system 103 serves as a last layer of cache in the processor before instructions and/or data are evicted to system memory 108. Each core typically has one or more of its own internal caching levels.

The memory controller 104 reads/writes data and instructions from/to system memory 108. The I/O hub 105 manages communication between the processor and “I/O” devices (e.g., non volatile storage devices and/or network interfaces). Port 106 stems from the interconnection network 102 to link multiple processors so that systems having more than N cores can be realized. Graphics processor 107 performs graphics computations. Power management circuitry (not shown) manages the performance and power states of the processor as a whole (“package level”) as well as aspects of the performance and power states of the individual units within the processor such as the individual cores 101_1 to 101_N, graphics processor 107, etc. Other functional blocks of significance (e.g., phase locked loop (PLL) circuitry) are not depicted in FIG. 1 for convenience.

As is understood in the art, each core typically includes at least one instruction execution pipeline. An instruction execution pipeline is a special type of circuit designed to handle the processing of program code in stages. According to a typical instruction execution pipeline design, an instruction fetch stage fetches instructions, an instruction decode stage decodes the instruction, a data fetch stage fetches data called out by the instruction, an execution stage containing different types of functional units actually performs the operation called out by the instruction on the data fetched by the data fetch stage (typically one functional unit will execute an instruction but a single functional unit can be designed to execute different types of instructions). A write back stage commits an instruction's results to register space coupled to the pipeline. This same register space is frequently accessed by the data fetch stage to fetch instructions as well.

### BRIEF DESCRIPTION OF THE DRAWINGS

A better understanding of the present invention can be obtained from the following detailed description in conjunction with the following drawings, in which:

FIG. 1 is a block diagram illustrating an exemplary multi-core processor;

FIGS. 2a-c illustrate a simplified depiction of a multi-core processor having different types of processing cores, each of which include different architectural state;

FIG. 3 illustrates one embodiment of an architecture for swapping architectural state between processor cores;

FIG. 4 illustrates additional details for one embodiment of an architecture for swapping architectural state between processor cores;

FIG. 5 illustrates one embodiment of a method for swapping architectural state between processor cores;

FIG. 6 illustrates one embodiment of an architecture for swapping architectural state between single threaded cores and simultaneous multithreading (SMT) cores; and

FIG. 7 illustrates one embodiment of a system architecture which includes a controller for exposing logical processors to software.

### DETAILED DESCRIPTION

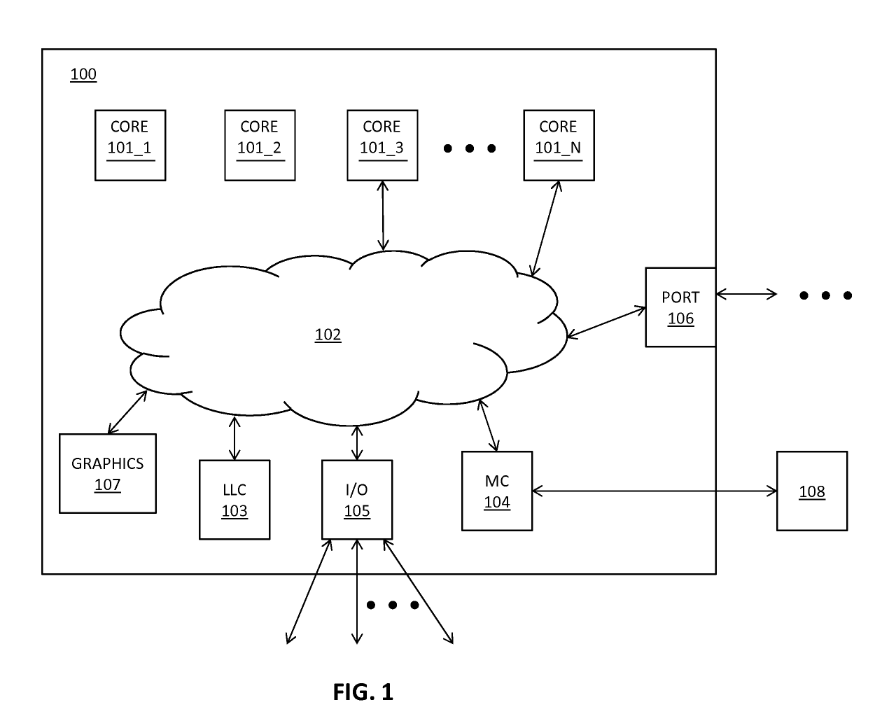

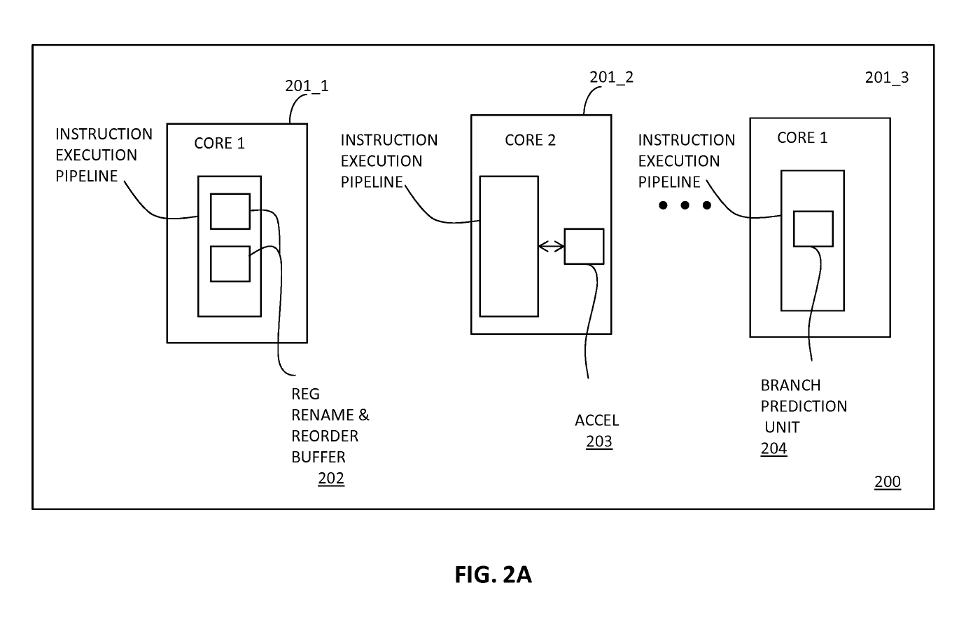

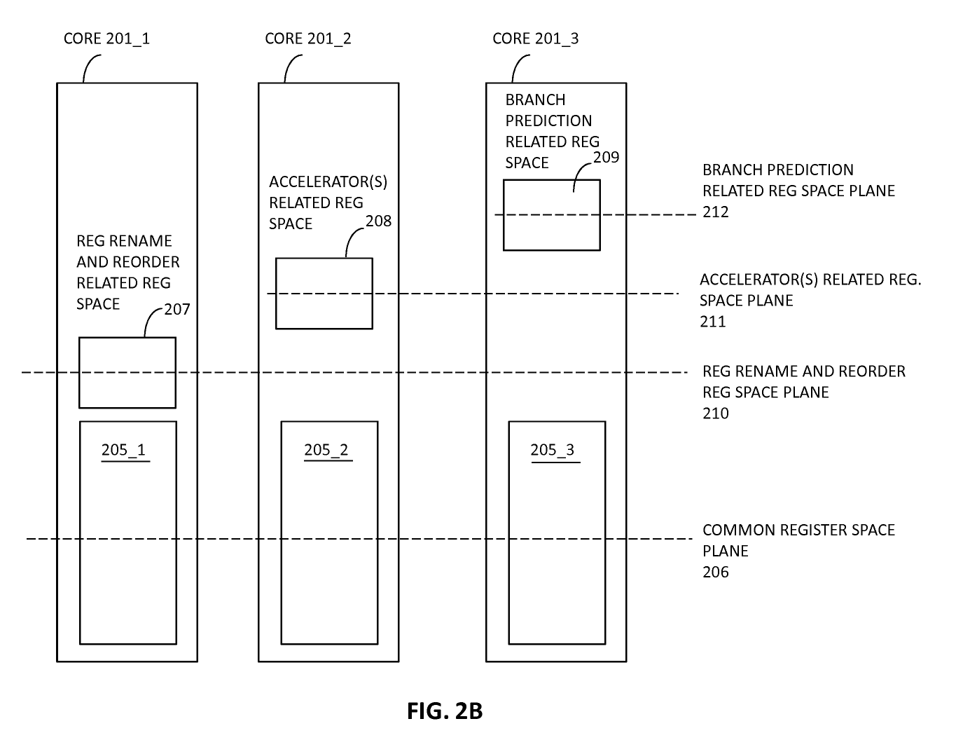

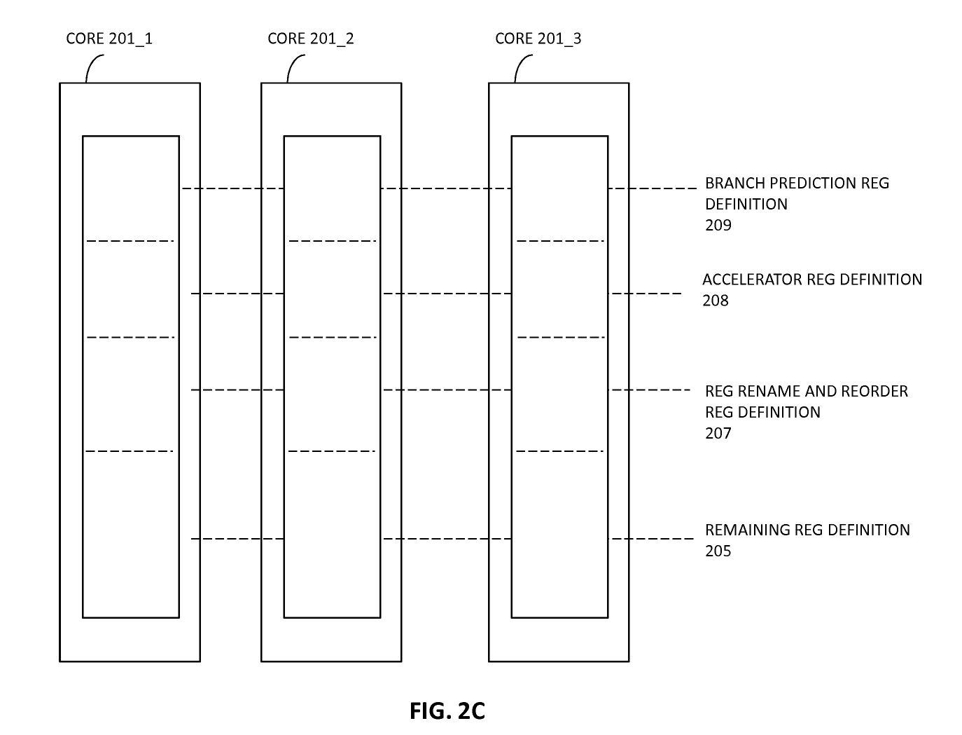

FIG. 2a shows a simplified depiction of a multi-core processor 200 having different types of processing cores. For convenience, other features of the processor 200, such as any/all of the features of the processor 100 of FIG. 1, are not depicted. Here, for instance, core 201_1 may be a core that contains register renaming and reorder buffer circuitry 202 to support out-of-order execution but does not contain special offload accelerators or branch prediction logic. Core 201_2, by contrast, may be a core that contains special offload accelerators 203 to speed up execution of certain computation intensive instructions but does not contain any register renaming or reorder buffer circuitry or branch prediction logic. Core 201_3, in further contrast, may be a core that contains special branch prediction logic 204 but does not contain any register renaming and reorder buffer circuitry or special offload accelerators.

A processor having cores of different type is able to process different kinds of threads more efficiently. For example, a thread detected as having many unrelated computations may be directed to core 201_1 because out-of-order execution will speed up threads whose data computations do not contain a high degree of inter-dependency (e.g., the execution of a second instruction does not depend on the results of an immediately preceding instruction). By contrast, a thread detected as having certain kinds of numerically intensive computations may be directed to core 201_2 since that core has accelerators 203 designed to speed-up the execution of instructions that perform these computations. Further still, a thread detected as having a certain character of conditional branches may be directed to core 201_3 because branch prediction logic 204 can accelerate threads by speculatively executing instructions beyond a conditional branch instruction whose direction is unconfirmed but nevertheless predictable.

By designing a processor to have different type cores rather than identical cores each having a full set of performance features (e.g., all cores have register renaming and reorder buffering, acceleration and branch prediction), semiconductor surface area is conserved such that, for instance, more cores can be integrated on the processor.

In one embodiment, all the cores have the same instruction set (i.e., they support the same set of instructions) so that, for instance, a same thread can migrate from core to core over the course of its execution to take advantage of the individual core's specialties. For example a particular thread may execute on core 201_1 when its instruction sequence is determined to have fewer dependencies and then migrate to core 201_2 when its instruction sequence is determined to have certain numerically intensive computations and then migrate again to core 201_3 when its instruction sequence is determined to have a certain character of conditional branch instructions.

It should be noted, however, that the cores may support different instruction set architectures while still complying with the underlying principles of the invention. For example, in one embodiment, the cores may support different ISA extensions to the same base ISA.

The respective instruction execution pipelines of the cores 201_1 through 201_3 may have identical functional units or different functional units, depending on the implementation. Functional units are the atomic logic circuits of an instruction execution pipeline that actually perform the operation called out by an instruction with the data called out by the instruction. By way of a simple example, one core might be configured with more Add units and thus be able to execute two add operations in parallel while another core may be equipped with fewer Add units and only be capable of executing one add in a cycle. Of course, the underlying principles of the invention are not limited to any particular set of functional units.

The different cores may share a common architectural state. That is, they may have common registers used to store common data. For example, control register space that holds specific kinds of flags set by arithmetic instructions (e.g., less than zero, equal to zero, etc.) may be the same across all cores. Nevertheless, each of the cores may have its own unique architectural state owing to its unique features. For example, core 201_1 may have specific control register space and/or other register space that is related to the use and/or presence of the register renaming and out of order buffer circuitry 202, core 201_2 may have specific control register space and/or other register space that is related to the use and/or presence of accelerators 203, core 201_3 may have specific control register space and/or other register space that is related to the use and/or presence of branch prediction logic 204.

Moreover, certain registers may be exposed to certain types of software whereas other registers may be hidden from software. For example, register renaming and branch prediction registers are generally hidden from software whereas performance debug registers and soft error detection registers may be accessed via software.

FIG. 2b shows the architectural state scenario schematically. The common/identical set of register space 205_1, 205_2, 205_3 for the three cores is depicted along a same plane 206 since the represent the equivalent architectural variables. The register space definition 207, 208, 209 that is unique to each of the cores 201_1, 201_2, 201_3 owing to their unique features (out-of-order execution, acceleration, branch prediction) are drawn on different respective planes 210, 211, 212 since they are each unique register space definitions by themselves.

A problem when a thread migrates from one core to another core is keeping track of the context (state information) of the unique register space definitions 207, 208, 209. For example, if a thread is executing on core 201_1 and builds up state information within unique register space 207 and then proceeds to migrate to core 201_2 not only is there no register space reserved for the contents of register space 207, but also, without adequate precautions being taken, core 201_2 would not know how to handle any reference to the information within register space 207 while the thread is executing on core 201_2 since it does not have features to which the information pertains. As such, heretofore, it has been the software's responsibility to recognize which information can and cannot be referred to when executing on a specific type of core. Designing in this amount of intelligence into the software essentially mitigates the performance advantage of having different core types by requiring more sophisticated software to run on them (e.g., because the software is so complex, it is not written or is not written well enough to function).

In an improved approach the software is not expected to comprehend all the different architectural and contextual components of the different core types. Instead the software is permitted to view each core, regardless of its type, as depicted in FIG. 2c. According to the depiction of FIG. 2c, the software is permitted to entertain an image of the register content of each core as having an instance of the register definition 205 that is common to the all the cores (i.e., an instance of the register definition along plane 206 in FIG. 2b) and an instance of each unique register definition that exists across all the cores (i.e., an instance of register definition 207, 208 and 209). In a sense, the software is permitted to view each core as a “fully loaded” core having a superset of all unique features across all the cores even though each core, in fact, has less than all of these features.

By viewing each core as a fully loaded core, the software does not have to concern itself with different register definitions as between cores when a thread is migrated from one core to another core. The software simply executes as if the register content for all the features for all the cores are available. Here, the hardware is responsible for tracking situations in which a thread invokes the register space associated with a feature that is not present on the core that is actually executing the thread.

In a heterogeneous CPU system such as described above, one way in which the architectural context may be migrated from one core to another core is by saving all the context (architectural state plus the micro-architectural state which impacts behavior) in a temporary storage location. This is the same kind of context storing that would need to take place to enable removing power from that core and later restore execution as if it had been just “waiting.” Once the context store is complete, the target core for the migration loads the complete context and begins execution as this logical processor.

One problem with this method is that there is a large time and energy overhead required for moving the processor context into this temporary location before loading it onto the target processor core.

To address this issue, one embodiment allows cores to exchange architectural state directly, thereby mitigating the need for a “temporary” migration state storage. This “direct” migration can either be “Pulled” by the target core loading the state from the source core or by being “Pushed” by the source core.

If the system is such that one of the two cores involved is always without a context then the direct data transfer can occur without concern about the architectural state/context at the target core. But if both cores are “active”, meaning exposed to software and assumed to be available, then the context of the target core must be retained in some way.

In one embodiment, a simultaneous “swap” of the context is performed between the two cores. In another embodiment, one direction of the “swap” is given priority and the other direction's context is delayed (e.g., through a temporary storage area). Optimizations may be included to reduce the amount of temporary storage by doing this “swap back” direction in smaller blocks as well.

While the embodiments described herein focus on swapping state between heterogeneous cores, the underlying principles are not limited to a heterogeneous core implementation. For example, the same direct state migration described herein may also be beneficial for hardware thread swapping among homogeneous cores.

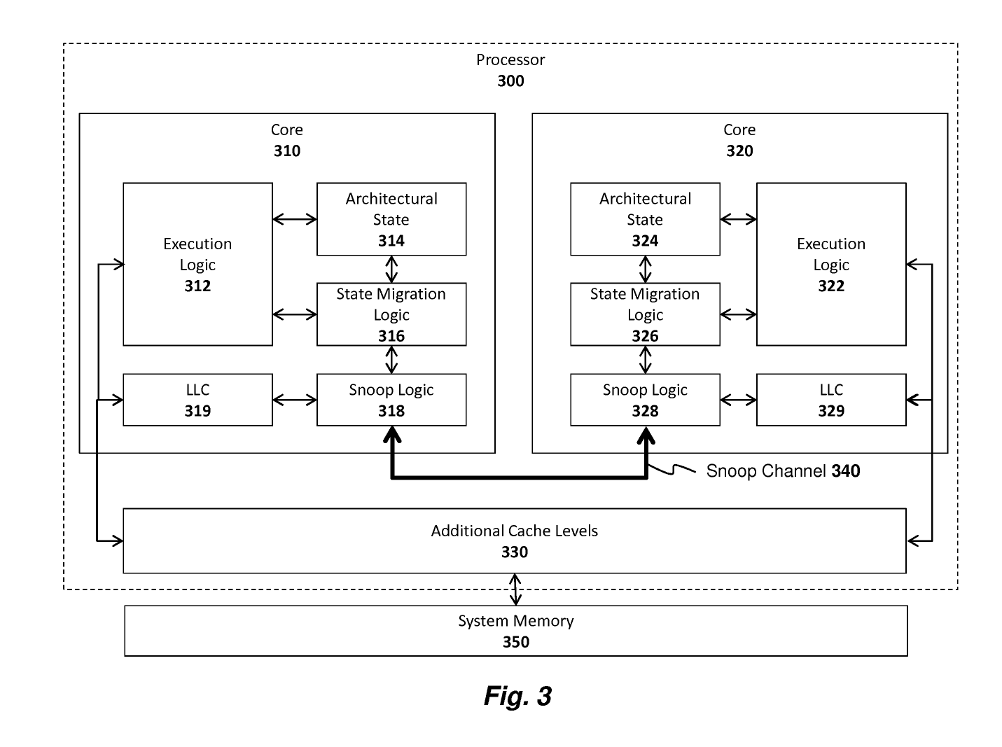

One embodiment of an architecture for swapping architectural context between two cores will be described with respect to FIG. 3 which illustrates a processor 300 with two or more cores 310, 320. Core 310 in the exemplary architecture includes a set of registers (e.g., control registers, floating point registers, integer registers, etc) for storing the current architectural state 314 (i.e., the current “context”) of one executing thread and core 320 includes a set of registers for storing the current architectural state 324 of another executing thread.

Each core 310, 320, includes execution logic 312, 322, respectively, for executing instructions and processing data using known techniques (which will not be described in detail here to avoid obscuring the underlying principles). Each core 310, 320 also includes one or more levels of cache memory such as a lower level cache (LLC) 319, 329 (also referred to as a level 1 (L1) cache), respectively, for storing instructions and data locally for more efficient execution. Additional cache levels 330 such as a level 2 (L2) or mid-level cache MLC and a level 3 (L3) or upper level (ULC) may be shared among the cores. The various cache levels form part of a memory subsystem which couples the processor to an external system memory 350 and coordinates memory transactions among the cache levels and memory 350 using known memory access/caching techniques.

In one embodiment, each core 310, 320 includes state migration logic 316, 326, respectively, which controls and coordinates the exchange of architectural state 314, 324 when migrating threads between the cores. In one specific embodiment, the state migration logic 316, 326 utilizes existing snoop logic 318, 328 to allow a first core 320 to request architectural state from a second core 310 in response to a thread being migrated from the first core to the second core. Snoop logic, as well understood by those of skill in the art, implements a bus snooping protocol in multiprocessor and multi-core processor systems to achieve cache coherence between the various caches in each of the processors/cores.

One of the advantages of using the snoop logic 318, 328 is that the snoop logic already has all the correct datapaths for moving state from one core to a peer. If one core needs ownership of a line which is currently owned by a different core, the snoop process is what allows the transfer of ownership and the latest data to the target core. In the same way, using the embodiments, a peer core can use these snoop datapaths to collect the architectural state of another core. Reusing datapaths that already exist to support snoop operations means that the embodiments may be implemented without significant additional logic and/or datapath structures.

In one embodiment, if a determination is made that a thread currently being executed by core 310 would be executed more efficiently and/or with greater power savings on core 320 (e.g., because of the unique capabilities of core 320), then the state migration logic 326 of core 320 may send a request for the architectural state 314 stored in core 310 using the snoop logic 328. The corresponding snoop logic 318 on core 310 receives the request and the state migration logic 316 on core 310 coordinates with state migration logic 326 on core 320 to swap the architectural states 314, 324 between the cores (or to simply transfer the architectural state 314 to core 320 if core 320 is not actively executing a different thread).

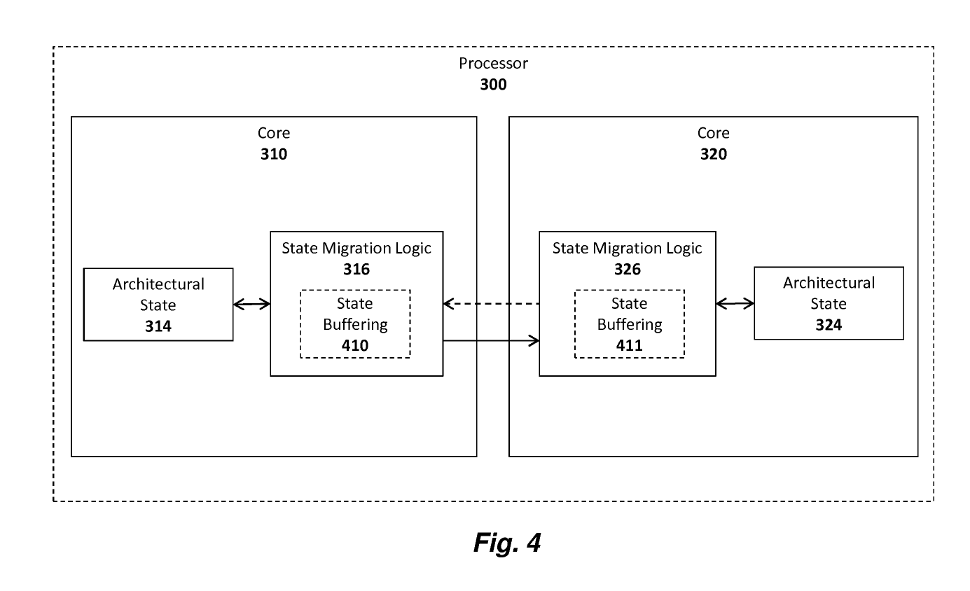

Different embodiments may utilize different techniques for swapping the architectural state of the cores. For example, as illustrated in FIG. 4, the state migration logic 316 and 326 may includes some amount of architectural state buffer logic 410 and 411, respectively, for temporarily storing the items of architectural state in transition between each core's register file.

The size of the architectural state buffer logic 410, 411 may vary from 0 (i.e., no buffering) to the size of the full architectural state (i.e., buffer all state), depending on the manner in which the cores exchange the state information. The buffer logic 410, 411 may be sized to store various portions of the register set, depending on the configuration. For example, in one embodiment, the target/requesting core 320 may save off all of its current state information to a temporary storage location and may then receive all architectural state information directly from core 310. The prior state of core 320 may subsequently be transferred to core 310 from the temporary storage location. In this embodiment, the temporary storage location may be a cache or other storage outside of the context of the state migration logic (i.e., the state buffering logic 410, 411 is not utilized). In an alternate embodiment, the state buffering logic 410, 411 may be utilized as the temporary storage location, and must therefore be sufficiently large to hold all of the architectural state from one of the two cores 310, 320.

In another embodiment, cores 310 and 320 may exchange state information one register at a time. In this embodiment, core 320 may initiate the process with a request for the contents of “Register 1” and core 310 responds with a copy of the state information in “Register 1.” At the same time, core 310 requests a copy of “Register 1” and core 320 responds with a copy of the state information in its version of “Register 1.” Once completed for “Register 1” the same process may be implemented in sequence for each additional register storing architectural state for each core. In this embodiment, the state buffering 410, 411 needs to only be large enough to buffer data from a single register in transition between the two cores 310, 320 (e.g., the size of the largest single register within each core), thereby significantly reducing the size requirements for the state buffering logic 410, 411.

By way of another example, the request for “register 1” sent from the target core 320 may include the target core's original value for register 1. The source core 310 may then use a “replace” operation to swap the new value (received in the request) for the old value and return the old value to the target core 320. In this embodiment, each register may be swapped without using any temporary storage.

In yet another embodiment, multiple pieces of architectural state may be transferred in blocks of registers (e.g., grouping registers into “blocks”). For example, all of the integer registers may be transferred from core 310 to core 320 first, followed by floating point registers, control registers, etc. This may be accomplished in one embodiment using state buffering 410, 411 sized according to the largest single block of state information to be transferred. This embodiment has the benefit of performing state transfers more efficiently than single register transfers (i.e., transferring register data in blocks rather than one register at a time) but requires a larger amount of buffer memory for storing the blocks of data.

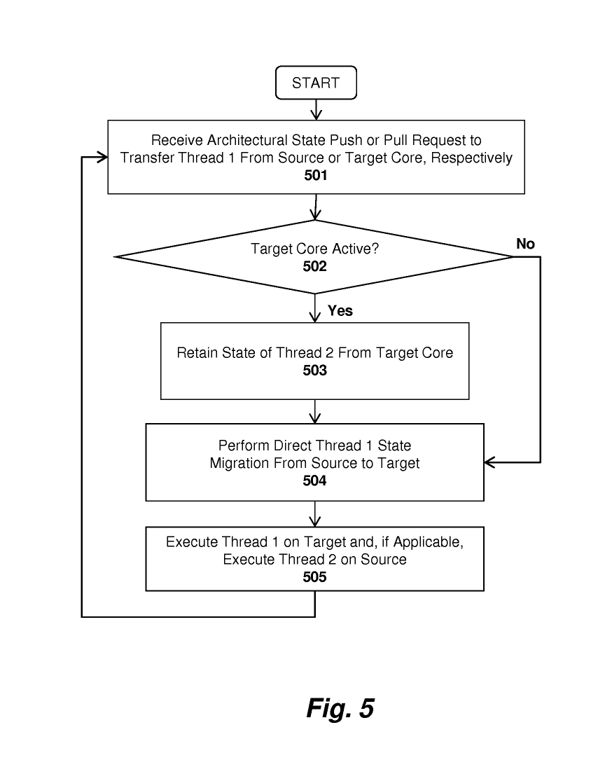

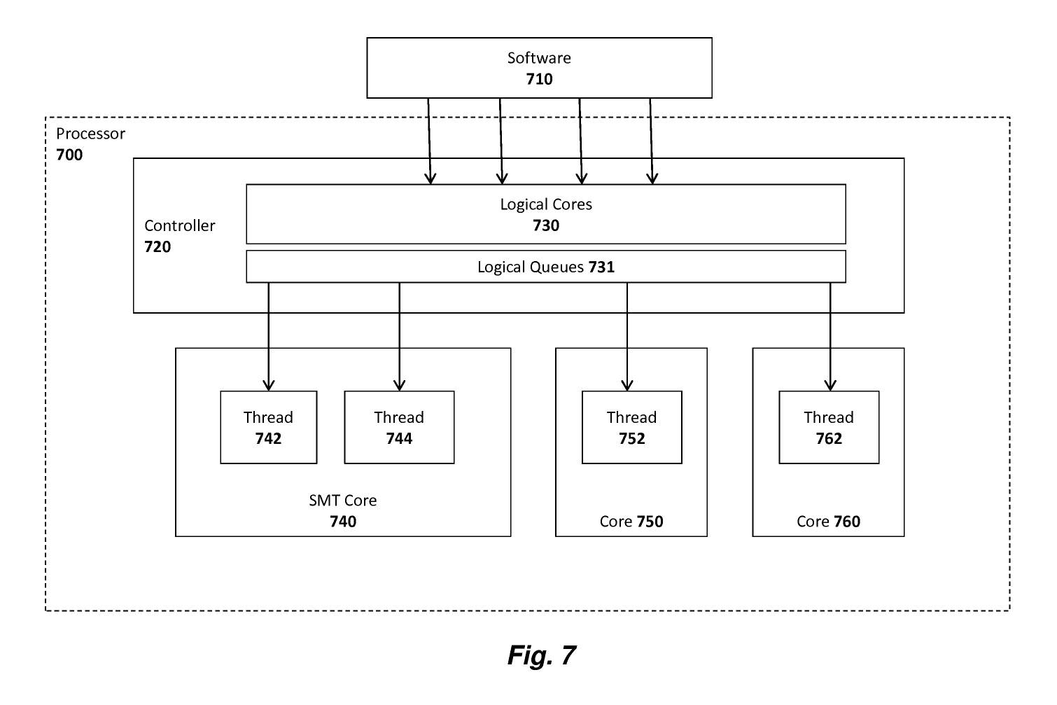

A method in accordance with one embodiment is illustrated in FIG. 5. At 501, an architectural state push or pull request is received to transfer Thread 1 from a source to a target core, respectively. In one embodiment, the target core to which Thread 1 is to be migrated initiates the state transfer via a “pull” request. For example, an instruction sequence in the thread may be detected which can be executed more efficiently on the target core and logical processor controller (see, e.g., FIG. 7 and associated text below) may schedule this portion of the thread for execution on the target core. In response, the target core may initiate the pull request to the source core for the architectural state of Thread 1. Alternatively, the source core may detect the instruction sequence and responsively initiate a “push” request to the target co re.

Regardless of whether a “push” or “pull” paradigm is used, at 502 a determination is made as to whether the target core is active (i.e., currently executing a different thread, Thread 2). If not, then the source core may directly transfer its architectural state to the target core at 504 because there is no active architectural state in the target core which needs to be retained. If the target is executing Thread 2, then at 503, the state of the target core is retained using one or more of the techniques described above. For example, all of the target core's architectural state may be saved to temporary storage prior to the state migration from the source to the target core. Alternatively, the registers from the source core may be copied to the target core and the registers from the target core may be copied to the source core one register at a time, or in blocks of registers as described above (e.g., using the architectural state buffers 410, 411). At 505, Thread 1 is executed on the target core and, if applicable, Thread 2 is executed on the source core.

Heterogeneous processors can be implemented such that all cores are active and exposed to software, meaning that all hardware cores are seen in software and the logical cores can be “swapped” between the physical cores for optimal behavior. Alternatively, heterogeneous processors may be designed where only some of the cores are exposed to software and the choice of which physical core type is used to execute a thread can be made based on optimal behavior at the time.

One embodiment is implemented using the latter “some cores exposed” model in a processor has both high performance/high power cores and low performance/low power cores. The heterogeneous processor may choose the optimal core type for each thread at all times, maximizing performance and power savings.

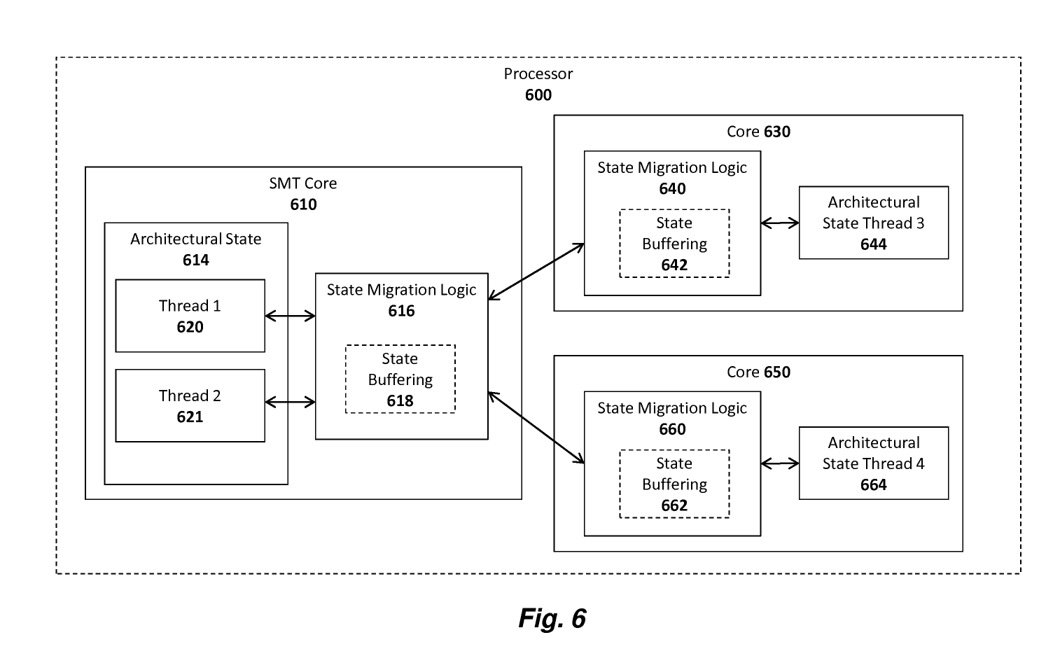

FIG. 6 illustrates one embodiment in which at least one of the cores is a simultaneous multithreading (SMT) core 610 capable of concurrently executing multiple threads (e.g., using hyper-threading or other simultaneous multithreading technology) and the other cores, 630 and 650, are single-threaded cores (configured to process a single thread at a time). In one embodiment, the core 610 supporting SMT appears to software as two separate cores while the non-SMT cores 630, 650 each appear as only a single core. In such a system, the cores 610 with SMT may take advantage of the SMT technology and continue to expose both logical processor threads to the software.

In the example shown in FIG. 6, SMT core 610 initially maintains an architectural state 614 for two different threads: Thread 1 620 and Thread 2 621 (i.e., it is actively executing the two threads); core 630 initially maintains an architectural state 644 for Thread 3; and core 650 initially maintains an architectural state 664 for Thread 4. State migration logic 616 on the SMT core 610 may coordinate with state migration logic 640, 660 on cores 630, 650 to move the architectural states 620 and 621 for Threads 1 and 2, respectively, to cores 630 and 650, while maintaining the current architectural states 644 and 664 for Threads 3 and 4, respectively. In one embodiment, similar techniques as those described above may be used to migrate the threads to the new cores (with the primary difference being that migration is performed between some SMT cores and some single-threaded cores). For example, state buffering 618, 642, 662 may be used to temporarily buffer the architectural state 620 and 621 as Threads 1 and 2, respectively, are moved to cores 630 and 650. Similarly, the state buffering 618, 642, 662 may be used to temporarily buffer the architectural state 644 and 664 as Threads 3 and 4, respectively, are moved to SMT core 610. The transfer may be done on a register-by-register basis, may be done in blocks, or may be done all at once, as discussed above with respect to FIG. 4. One difference which may exist in a system with an SMT core 610 is that there may be some architectural state which is shared between Thread 1 and Thread 2 when executed on the SMT core 610 (i.e., shared architectural state). By way of example, and not limitation, both cores may share the same memory type range registers (MTRRs), which are control registers that provide system software with control of how accesses to certain memory ranges are cached. When Threads 1 and 2 are migrated to cores 630 and 650, it is possible (under certain conditions) that the threads will receive different MTRR values when executed on the new cores. This may result in problems if the threads migrate back to the SMT core 610. One embodiment includes state synchronization logic to ensure that any state which would be shared on an SMT core is maintained consistently when threads are executed on different cores. In addition, in one embodiment, when threads are migrated to the SMT core 610, the state synchronization logic may check to ensure that the shared state is the same. If the synchronization logic finds an inconsistency in the shared architectural state from the plurality of single-threaded cores, the state synchronization logic may set a bit to indicate the inconsistency. This bit may be set for debug purposes and/or one of the two values of state information may be selected (e.g., the first value detected) and the other discarded.

FIG. 7 illustrates one embodiment of a controller 720 for exposing a set of logical cores 730 to software 710 and mapping the logical cores 730 to physical cores 740, 750, 760 within the processor 700. In the illustrated example, the controller 720 has mapped Threads 742 and 744 to SMT core 740; Thread 752 to core 750; and Thread 762 to core 760. In response to various changes in the system (e.g., changes to the sequence of instructions within each of the threads, changes to power/performance requirements, etc), the controller 720 may subsequently re-map the threads across each of the different cores. In this case, the controller 720 (or other logic within the processor/core) may direct the state migration logic 616, 640, 660 to migrate the state information for each thread prior to execution of that thread on its new core.

As illustrated in FIG. 7, a set of logical queues 731 may be established and managed by the controller 720 for each of the cores 740, 750, 760. Thus, if there are multiple threads which must be executed on a particular physical core (e.g., because of the unique capabilities of that core), those threads and associated logical processors may be allocated to the queue for that particular core. In this example, the particular physical core will operate on threads from its logical queue one at a time (if it is a single-threaded core) or multiple at a time (if an SMT core).

It should be noted that the controller 720 illustrated in FIG. 7 may be implemented using hardware, software, firmware, or any combination thereof. For example, in one embodiment it may be implemented within a kernel or scheduler of an operating system. In addition, it should be noted that a “direct” swap of architectural state as described herein may be implemented with or without temporary buffers (e.g., buffers within the state migration logic as discussed above).

Processes taught by the discussion above may be performed with program code such as machine-executable instructions which cause a machine (such as a “virtual machine”, a general-purpose CPU processor disposed on a semiconductor chip or special-purpose processor disposed on a semiconductor chip) to perform certain functions. Alternatively, these functions may be performed by specific hardware components that contain hardwired logic for performing the functions, or by any combination of programmed computer components and custom hardware components.

A storage medium may be used to store program code. A storage medium that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

We claim:

1. A processor, comprising:
a first processing core having a first instruction execution pipeline including first register set for storing a first architectural state of a first thread being executed thereon;
a second processing core having a second instruction execution pipeline including a second register set for storing a second architectural state of a second thread being executed thereon; and
architectural state migration logic to perform a direct swap of the first architectural state from the first register set with the second architectural state from the second register set responsive to detecting that the execution of the first thread is to be migrated from the first core to the second core.

2. The processor as in claim 1 wherein the direct swap is performed by swapping the architectural state from one register at a time from the first register set and the second register set.

3. The processor as in claim 1 wherein the direct swap is performed by swapping the architectural state from a block of registers at a time from the first register set and the second register set.

4. The processor as in claim 1 wherein the direct swap is performed by concurrently swapping all of the architectural state from the first register set with the second register set.

5. The processor as in claim 1 wherein the architectural state migration logic includes buffer logic to temporarily buffer portions of the architectural state during the direct swap of the first architectural state from the first register set with the second architectural state from the second register set.

6. The processor as in claim 5 wherein the buffer logic is located on each of the first and second cores involved in the direct swap.

7. The processor as in claim 1 further comprising:
a controller to determining that the first thread is to be migrated from the first core to the second core.

8. The processor as in claim 7 wherein the controller comprises a plurality of logical processors exposed to software for executing the first thread, the second thread, and one or more other threads.

9. The processor as in claim 7 wherein the determination is made by the controller based on detecting that one or more instructions of the first thread can be executed more efficiently by the second instruction execution pipeline of the second core.

10. The processor as in claim 7 wherein the determination is made by the controller based on detecting that one or more instructions of the first thread can be executed at lower power by the second instruction execution pipeline of the second core.

11. The processor as in claim 1 wherein the first core comprises a simultaneous multithreading (SMT) core and the second core comprises a single-threaded core.

12. The processor as in claim 11 wherein the SMT core includes certain registers containing architectural state shared between threads.

13. The processor as in claim 12 wherein, when swapping the shared architectural state into the SMT core from a plurality of single-threaded cores, state synchronization logic checks to ensure that the shared architectural state from the plurality of single-threaded cores is consistent.

14. The processor as in claim 13 wherein, if the synchronization logic finds an inconsistency in the shared architectural state from the plurality of single-threaded cores, the state synchronization logic is to set a bit to indicate the inconsistency.

15. The processor as in claim 1 further comprising:
snoop logic usable by the architectural state migration logic to perform the a direct swap of the first architectural state from the first register set with the second architectural state from the second register set.

16. A method comprising:
storing a first architectural state of a first thread in a first register set of a first processing core having a first instruction execution pipeline;
storing a second architectural state of a second thread in a second register set of a second processing core having a second instruction execution pipeline; and
performing a direct swap of the first architectural state from the first register set with the second architectural state from the second register set responsive to detecting that the execution of the first thread is to be migrated from the first core to the second core.

17. The method as in claim 16 wherein the direct swap is performed by swapping the architectural state from one register at a time from the first register set and the second register set.

18. The method as in claim 16 wherein the direct swap is performed by swapping the architectural state from a block of registers at a time from the first register set and the second register set.

19. The method as in claim 16 wherein the direct swap is performed by concurrently swapping all of the architectural state from the first register set with the second register set.

20. The method as in claim 16 wherein portions of the architectural state are stored in a buffer during the direct swap of the first architectural state from the first register set with the second architectural state from the second register set.
